(19) United States
(12) Patent Application Publication
(10) Pub. No.: US 2017/0005392 A1
(43) Pub. Date: Jan. 5, 2017

(54) MOBILE DEVICE WITH LDS ANTENNA MODULE AND METHOD FOR MAKING LDS ANTENNA MODULE

(71) Applicants: Seokjin Hwang, Singapore (SG); JongHoon Yoon, Singapore (SG)

(72) Inventors: Seokjin Hwang, Singapore (SG); JongHoon Yoon, Singapore (SG)

(73) Assignee: AAC Technologies Pte. Ltd., Singapore city (SG)

(21) Appl. No.: 15/008,598

(22) Filed: Jan. 28, 2016

(30) Foreign Application Priority Data
Jul. 2, 2015 (CN) 201510382025.7

(51) Int. Cl. H01Q 1/24; H01Q 21/00; H01Q 21/06; H01Q 9/04; H01Q 7/00

(52) U.S. Cl. CPC H01Q 1/241; H01Q 9/04; H01Q 7/00; H01Q 21/061; H01Q 21/0087

(57) ABSTRACT

A mobile device with a laser direct structuring (LDS) antenna module is provided in the present disclosure. The mobile device includes a glass back cover and an LDS antenna module on the glass back cover. The LDS antenna module includes an LDS coating layer formed on a main surface of the glass back cover, and at least one antenna unit formed at the LDS coating layer by LDS process. The present disclosure also provides a method for making an LDS antenna module.

### FIELD OF THE DISCLOSURE

The present disclosure generally relates to mobile communication technologies, and more particularly, to a mobile device with a laser direct structuring (LDS) antenna module and a method for making the LDS antenna module.

### BACKGROUND

With development of mobile communication technologies, mobile devices such as mobile phones, tablet computers, or the like, are used more and more widely. Mobile devices normally use antenna modules to convert electric power into radio waves, and vice versa, so as to realize wireless transmission and reception.

An LDS antenna module generally includes an antenna pattern formed on a plastic base by LDS process. However, because the LDS antenna module needs to be formed on the plastic base, when a shell or cover of the mobile device uses material other than plastic, the LDS antenna cannot be directly formed on the shell or cover; instead, the LDS antenna needs to be formed on a plastic plate disposed inside the mobile device. In this circumstance, the LDS antenna module may be interfered by neighboring electrical components inside the mobile device, and accordingly, a radio frequency (RF) performance of the LDS antenna module may decrease.

Therefore, it is desired to provide a new mobile device with an LDS antenna module which can overcome the aforesaid problems.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic exploded view of a mobile device with an LDS antenna module according to an embodiment of the present disclosure.

FIG. 2 is a flow chart of a method for making an LDS antenna module according to an embodiment of the present disclosure.

### DETAILED DESCRIPTION

The present disclosure will be described in detail below with reference to the attached drawings and the embodiment thereof.

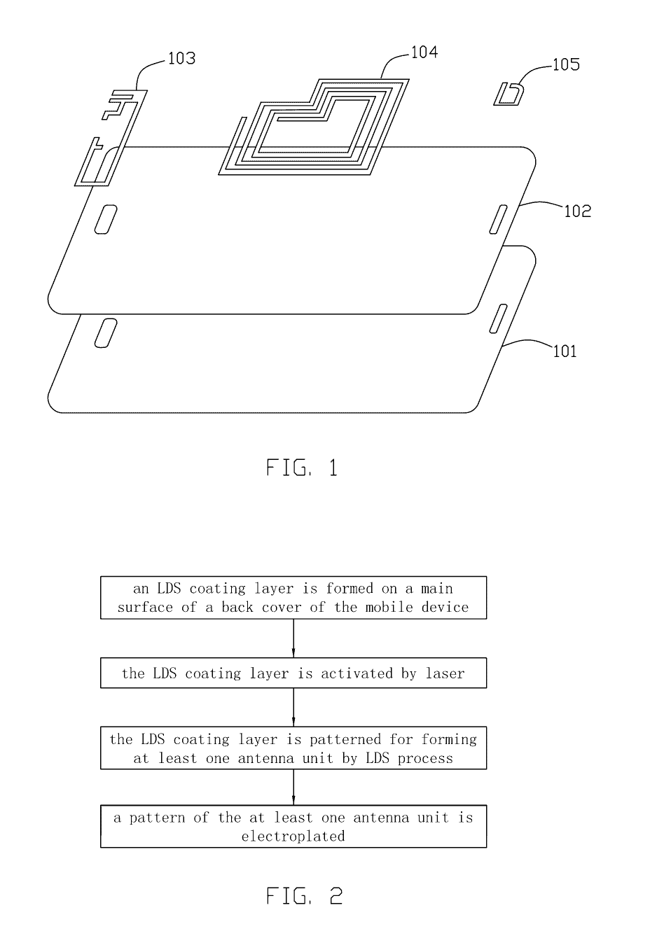

Referring to FIG. 1, a mobile device according to an embodiment of the present disclosure is shown. The mobile device may be a mobile phone, a tablet computer, or the like. The mobile device includes a back cover 101 and an LDS antenna module on a main surface of the back cover 101. The back cover 101 may be a glass back cover. The LDS antenna module includes a

LDS coating layer 102 formed on the main surface of the back cover 101, and at least one antenna unit formed at the LDS coating layer 102 by LDS process. Typically, the at least one antenna unit may include a plurality of antenna units 103 to 105 as illustrated in FIG. 1, and the mobile device may further include a circuit board and other electrical components therein; the antenna units 103 to 105 are electrically connected to the circuit board.

In the present embodiment, for example, the antenna units 103 to 105 may include a global positioning system (GPS) antenna unit 103, a near field communication (NFC) antenna unit 104, and a WIFI antenna unit 105.

Alternatively, in other embodiments, other kinds of antenna units may be formed at the LDS coating layer 102.

The LDS coating layer 102 is a laser-activated layer formed on the main surface of the back cover 101, the LDS coating layer 102 makes it possible to form the GPS antenna unit 103, the NFC antenna unit 104 and the

WIFI antenna unit 105 on the back cover 101. Optionally, a protecting layer may be further formed on the LDS coating layer 102, the protecting layer is configured for protecting the antenna units 103 to 105.

In the mobile device as provided in the present disclosure, the LDS coating layer 102 enables the LDS antenna module to be formed on the back cover 101; therefore, it is unnecessary to provide a plastic plate for carrying the LDS antenna module, and the LDS antenna module on the back cover 101 can prevented from being interfered by inner electrical components inside the mobile device. As such, the radio frequency (RF) performance of the LDS antenna module of the mobile device is improved.

FIG. 2 is a flow chart of a method for making an LDS antenna module according to an embodiment of the present disclosure. The method can be used to make the LDS antenna module of the mobile device as illustrated in FIG. 1; specifically, the method for making the LDS antenna module mainly includes the following steps:

Step S1, an LDS coating layer 102 is formed on a main surface of a back cover 101 of the mobile device;

Step S2, the LDS coating layer 102 is activated by laser;

Step S3, the LDS coating layer 102 is patterned for forming at least one antenna unit by LDS process; and

Step S4, a pattern of the at least one antenna unit is electroplated; in step S4, for example, the at least one antenna unit may be antenna units 103 to 105, and the patterns of the antenna units 103 to 105 may be electroplated with gold or copper nickel alloy.

Furthermore, the method for making the LDS antenna module may further include a step for forming a protecting layer on the LDS coating layer 102, and the protecting layer covers the patterns of the antenna units 103 to 105 to protect the antenna units 103 to 105.

In the method for making the LDS antenna as provided in the present disclosure, the antenna units are directly patterned on the LDS coating layer 102 activated by laser, and thus it is unneeded to implement an injection molding process and an etching process. Accordingly, the method for making the LDS antenna module is more simple; moreover, only the patterns of the antenna units are electroplated, this can save the electroplate material and bring down an overall cost of the LDS antenna module.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile device, comprising:
a back cover; and
a laser direct structuring (LDS) antenna module on the back cover;
wherein the LDS antenna module comprises an LDS coating layer formed on a main surface of the back cover, and at least one antenna unit formed at the LDS coating layer by LDS process.

2. The mobile device of claim 1, wherein the at least one antenna unit comprises a plurality of antenna units.

3. The mobile device of claim 2, wherein the plurality of antenna units comprise a global positioning system (GPS) antenna unit, a near field communication (NFC) antenna unit, and a WIFI antenna unit.

4. The mobile device of claim 1, wherein the LDS coating layer is a laser-activated layer formed on the main surface of the back cover.

5. The mobile device of claim 4, further comprising a protecting layer formed on the LDS coating layer for protecting the at least one antenna unit.

6. The mobile device of claim 1, wherein the LDS coating layer is patterned and electroplated for forming the at least one antenna unit after LDS coating layer being activated by laser.

7. The mobile device of claim 1, further comprising a circuit board, wherein the at least one antenna unit is electrically connected to the circuit board.

8. A method for making an LDS antenna module, comprising the steps of:
forming an LDS coating layer on a main surface of a back cover;
activating the LDS coating layer by laser;
patterning the LDS coating layer by LDS process for forming at least one antenna unit; and
electroplating a pattern of the at least one antenna unit.

9. The method of claim 8, wherein the at least one antenna unit comprises a plurality of antenna units.

10. The method of claim 9, wherein the plurality of antenna units comprise a global positioning system (GPS) antenna unit, a near field communication (NFC) antenna unit, and a WIFI antenna unit.

11. The method of claim 8, wherein the pattern of the at least one antenna unit is electroplated with gold or copper nickel alloy.

12. The method of claim 8, further comprising: forming a protecting layer on the LDS coating layer for protecting the at least one antenna unit.
